(19) United States
(12) Patent Application Publication
(10) Pub. No.: US 2025/0326064 A1
(43) Pub. Date: Oct. 23, 2025

(54) LASER PROCESSING APPARATUS, WORKPIECE CHAMFERING METHOD, AND WAFER MANUFACTURING METHOD

(71) Applicant: DISCO CORPORATION, Tokyo (JP)

(72) Inventors: Kazuya HIRATA, Tokyo (JP); Haruna YANO, Tokyo (JP)

(21) Appl. No.: 19/095,284

(22) Filed: Mar. 31, 2025

(30) Foreign Application Priority Data
Apr. 22, 2024 (JP) 2024-068820

(51) Int. Cl. B23K 26/361; B23K 26/402

(52) U.S. Cl. CPC B23K 26/361; B23K 26/402

(57) ABSTRACT

A laser processing apparatus includes a holding unit that has a flat holding surface, an oscillator that emits a laser beam, and a beam condenser that converges the laser beam emitted from the oscillator. The laser processing apparatus is capable of adjusting relative positions and orientations of the beam condenser and the holding unit such that the beam condenser faces a side surface of a workpiece held by the holding unit, and applying, from the side surface side to the workpiece held by the holding unit, the laser beam emitted from the oscillator and converged by the beam condenser.

### BACKGROUND OF THE INVENTION

### Field of the Invention

The present invention relates to a laser processing apparatus capable of chamfering a workpiece by applying, to the workpiece, a laser beam having a wavelength absorbable by the workpiece in such a manner that both an outer peripheral portion of a first surface side of the workpiece and an outer peripheral portion of a second surface side of the workpiece are removed, a workpiece chamfering method for chamfering a workpiece, and a wafer manufacturing method for manufacturing a chamfered wafer from an ingot.

### Description of the Related Art

Chips of devices exemplified by integrated circuits (ICs) are indispensable components for various kinds of electronic appliances including mobile phones and personal computers. Such chips are typically manufactured using chamfered wafers formed of a single crystal of silicon (Si), silicon carbide (SiC), gallium nitride (GaN), lithium tantalate (LiTaO₃: LT), or lithium niobate (LiNbO₃: LN). These wafers are, for example, manufactured as follows: first, a face side portion that is part of a cylindrical ingot and that has a predetermined thickness is cut out, and then, an outer peripheral portion of the cut-out portion (which is, what is generally called an as-sliced wafer) is processed to form a chamfered portion (see, for example, Japanese Patent Laid-open No. 2019-212761). Specifically, this chamfer processing is performed by applying, to the as-sliced wafer, a laser beam having a wavelength absorbable by a material constituting the as-sliced wafer in such a manner as to remove both an outer peripheral portion of a first surface side of the as-sliced wafer and an outer peripheral portion of a second surface side of the as-sliced wafer.

### SUMMARY OF THE INVENTION

A laser processing apparatus capable of applying chamfer processing to workpieces exemplified by as-sliced wafers typically includes a holding table that has a flat holding surface, an oscillator, a beam condenser that converges the laser beam emitted from the oscillator, and a moving mechanism that moves a focused spot of the laser beam and the holding table relative to each other. This kind of laser processing apparatus processes a workpiece by applying a laser beam to the workpiece in such a manner that the holding table and the focused spot are moved relative to each other in a state in which the focused spot is positioned inside the workpiece held on the holding surface of the holding table.

More specifically, when a workpiece is to be chamfered, first, a first surface side of the workpiece is held on the holding surface of the holding table such that a second surface side of the workpiece is exposed. Next, a laser beam is applied to the workpiece such that the holding table and the focused spot are moved relative to each other in a state in which the focused spot of the laser beam is positioned to an outer peripheral portion of the second surface side of the workpiece. This removes the outer peripheral portion of the second surface side of the workpiece. Subsequently, after the workpiece is separated from the holding surface of the holding table and turned upside down, the workpiece is held again on the holding surface of the holding table. That is, the second surface side of the workpiece is held on the holding surface of the holding table such that the first surface side of the workpiece is exposed. Thereafter, a laser beam is applied to the workpiece in such a manner that the holding table and the focused spot are moved relative to each other in a state in which the focused spot of the laser beam is positioned to the outer peripheral portion of the first surface side of the workpiece. This removes the outer peripheral portion of the first surface side of the workpiece.

However, the step of turning the workpiece upside down to apply laser processing from each of the surfaces in the manner described above takes time not only for turning the workpiece upside down but also for precisely detecting again the position of the workpiece on the holding surface and deciding the processing position after the workpiece has been turned upside down. Hence, chamfer processing by this method had the problem of low throughput.

It is accordingly an object of the present invention to provide a laser processing apparatus capable of performing chamfer processing on the workpiece with high throughput.

In accordance with an aspect of the present invention, there is provided a laser processing apparatus capable of applying laser processing to a workpiece by applying, to the workpiece, a laser beam having a wavelength absorbable by a material constituting the workpiece, the laser processing apparatus including a holding unit that has a flat holding surface, an oscillator that emits the laser beam, a beam condenser that converges the laser beam emitted from the oscillator, a moving mechanism that moves the holding unit and a focused spot of the laser beam relative to each other, and a rotation mechanism that rotates the holding unit about a rotational axis that is a straight line intersecting the holding surface of the holding unit, in which relative positions and orientations of the beam condenser and the holding unit are adjustable in such a manner that the beam condenser faces a side surface connecting a first surface and a second surface of the workpiece held by the holding unit, and the laser beam emitted from the oscillator and converged by the beam condenser is applicable from the side surface side to the workpiece held by the holding unit.

Preferably, a traveling direction of the laser beam is adjustable in such a manner that the laser beam enters the workpiece from the side surface thereof and travels up to the first surface or the second surface.

Further, preferably, the laser processing apparatus further includes a position detection unit that detects a positional relation between the beam condenser and the side surface of the workpiece held by the holding unit.

In accordance with another aspect of the present invention, there is provided a workpiece chamfering method for chamfering a workpiece, the workpiece chamfering method including holding a central portion of a first surface side of the workpiece on a flat holding surface of a holding unit such that outer peripheral portions of the workpiece are exposed, after the central portion of the first surface side of the workpiece is held on the flat holding surface of the holding unit, removing the outer peripheral portion of the first surface side of the workpiece by rotating the holding unit about a rotational axis that is a straight line intersecting the holding surface while applying, to the workpiece, a laser beam having a wavelength absorbable by a material constituting the workpiece such that the laser beam enters the workpiece from a side surface thereof and reaches up to the first surface side, and after the central portion of the first surface side of the workpiece is held on the flat holding surface of the holding unit, removing the outer peripheral portion of the second surface side of the workpiece by rotating the holding unit about the rotational axis while applying the laser beam to the workpiece such that the laser beam enters the workpiece from the side surface thereof and reaches up to the second surface side.

Preferably, the workpiece is not turned upside down between the removal of the outer peripheral portion of the first surface side of the workpiece and the removal of the outer peripheral portion of the second surface side of the workpiece.

In accordance with a further aspect of the present invention, there is provided a wafer manufacturing method for manufacturing a chamfered wafer from an ingot, the wafer manufacturing method including forming a separation layer inside the ingot by applying, to the ingot, a first laser beam having a wavelength transmittable through a material constituting the ingot in such a manner that the ingot and a first focused spot of the first laser beam are moved relative to each other in a state in which the first focused spot is positioned inside the ingot, peeling off a wafer from the ingot by applying external force to the ingot in such a manner that the ingot is cleaved in the separation layer, holding a central portion of a first surface side of the wafer on a flat holding surface of the holding unit such that both an outer peripheral portion of the first surface side of the wafer and an outer peripheral portion of a second surface side of the wafer are exposed, after the central portion of the first surface side of the wafer is held on the flat holding surface of the holding unit, removing the outer peripheral portion of the first surface side of the wafer by rotating the holding unit about a rotational axis that is a straight line intersecting the holding surface while applying, to the wafer, a second laser beam having a wavelength absorbable by a material constituting the wafer in such a manner that the second laser beam enters the wafer from a side surface thereof and reaches up to the first surface side, and, after the central portion of the first surface side of the wafer is held on the flat holding surface of the holding unit, removing the outer peripheral portion of the second surface side of the wafer by rotating the holding unit about the rotational axis while applying the second laser beam to the wafer in such a manner that the second laser beam enters the wafer from the side surface thereof and reaches up to the second surface side.

Preferably, the wafer is not turned upside down between the removal of the outer peripheral portion of the first surface side of the wafer and the removal of the outer peripheral portion of the second surface side of the wafer.

In the laser processing apparatus, the workpiece chamfering method, and the wafer manufacturing method according to aspects of the present invention, a laser beam is applied to a workpiece (wafer) from a side surface side of the workpiece. In this case, the laser beam can be applied to both the outer peripheral portion of the first surface side of the workpiece and the outer peripheral portion of the second surface side of the workpiece, making it unnecessary to turn the workpiece upside down at the time of chamfering the workpiece. This results in reduced trouble for the chamfering processing for the workpiece and increased throughput.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view schematically illustrating an example of a workpiece;

FIG. 2 is a perspective view schematically illustrating an example of a laser processing apparatus;

FIG. 3 is a block diagram schematically illustrating a configuration example of an optical system included in the laser processing apparatus;

FIG. 4 is a side elevational view schematically illustrating the manner in which a laser beam is applied from the side to a workpiece held by a holding unit;

FIG. 5A is a cross sectional view schematically illustrating the manner in which a laser beam is applied to an outer peripheral portion of a first surface side of the workpiece;

FIG. 5B is a cross sectional view schematically illustrating the manner in which a laser beam is applied to an outer peripheral portion of a second surface side of the workpiece;

FIG. 6 is a side elevational view schematically illustrating, in an enlarged form, outer peripheral portions of the chamfered workpiece;

FIG. 7A is a flowchart for describing a flow of steps of a workpiece chamfering method;

FIG. 7B is a flowchart for describing a flow of steps of a wafer manufacturing method;

FIG. 8A is a cross sectional view schematically illustrating the manner in which a separation layer is formed in an ingot in a separation laser forming step;

FIG. 8B is a cross sectional view schematically illustrating the manner in which a wafer is separated from the ingot in a peeling-off step;

FIG. 9 is a perspective view schematically illustrating another example of the laser processing apparatus; and

FIG. 10 is a perspective view schematically illustrating the other example of the laser processing apparatus.

### DETAILED DESCRIPTION OF THE PREFERRED EMBODIMENT

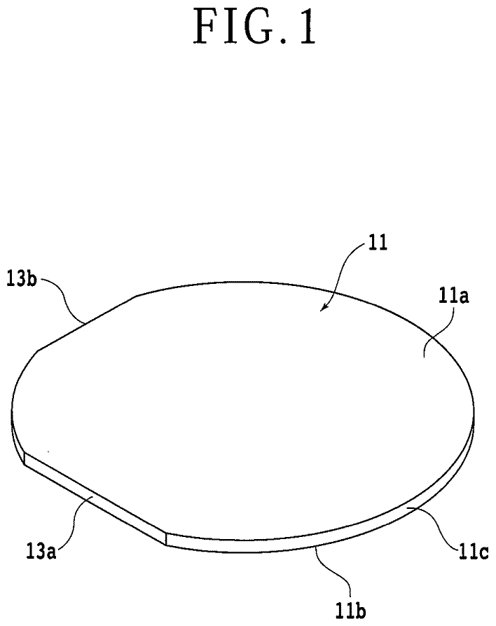

An embodiment according to an aspect of the present invention will be described with reference to the attached drawings. FIG. 1 is a perspective view schematically illustrating an example of a workpiece. The workpiece denoted by 11 and depicted in FIG. 1 is a circular plate-shaped wafer in which a first surface (face side) 11a and a second surface (reverse side) 11b that is an opposite surface of the first surface 11a are both mirror surfaces and both an outer peripheral portion of the first surface 11a side and an outer peripheral portion of the second surface 11b side have angled edges. On a side surface 11c of the workpiece 11, two flat portions for indicating the crystal orientation of a material constituting the workpiece 11, that is, a first orientation flat 13a and a second orientation flat 13b, are formed. Note that, in the drawings other than FIG. 1, illustration of the first orientation flat 13a and the second orientation flat 13b is omitted.

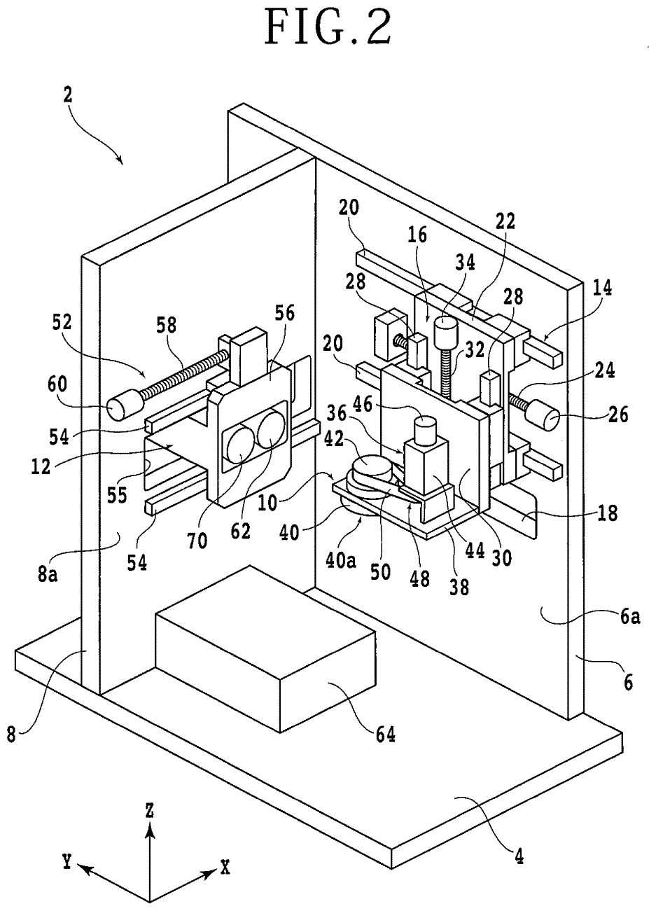

FIG. 2 is a perspective view schematically illustrating an example of a laser processing apparatus 2 that is capable of applying laser processing to the workpiece 11 by applying, from the side surface 11c to the workpiece 11, a laser beam having a wavelength absorbable by the workpiece 11. The laser processing apparatus 2 illustrated in FIG. 2 can chamfer the workpiece 11 by applying such a laser beam to the outer peripheral portion of the first surface 11a side of the workpiece 11 and the outer peripheral portion of the second surface 11b side of the workpiece 11. Note that, an X-axis direction and a Y-axis direction that are illustrated in FIG. 2 are directions perpendicular to each other on a horizontal plane, and a Z-axis direction is a direction (vertical direction) perpendicular to both the X-axis direction and the Y-axis direction.

The laser processing apparatus 2 illustrated in FIG. 2 has a base 4 that supports the components thereof. On the base 4, a support section (wall section) 6 for mainly supporting a holding unit 10 that holds the workpiece 11 and a support section (wall section) 8 for mainly supporting a laser beam application unit 12 that applies a laser beam toward the workpiece 11 are erected.

On a front surface 6a of the support section 6, a Y-axis moving mechanism 14 for moving the holding unit 10 along the Y-axis direction and a Z-axis moving mechanism 16 for moving the holding unit 10 along the Z-axis direction are provided. Further, the support section 6 is provided with a loading/unloading port 18 that serves as a movement path for the workpiece 11 that moves between a front side and a rear side of the support section 6. The workpiece 11 is loaded to the front side of the support section 6 through the loading/unloading port 18 from the rear side of the support section 6, subjected to processing, and then unloaded to the rear side of the support section 6 through the loading/unloading port 18 from the front side of the support section 6.

The Y-axis moving mechanism 14 includes a pair of Y-axis guide rails 20 that are fixed to the front surface 6a of the support section 6 and that extend along the Y-axis direction. To a front side of the pair of Y-axis guide rails 20, a Y-axis moving plate 22 is coupled in a slidable manner along the pair of Y-axis guide rails 20. Between the pair of Y-axis guide rails 20, a screw shaft 24 extending along the Y-axis direction is disposed. To a front end portion (one end portion) of the screw shaft 24, a motor 26 for rotating the screw shaft 24 is coupled. Moreover, on a surface of the screw shaft 24 in which a spiral groove is formed, an unillustrated nut accommodating numerous balls that roll on the surface of the rotating screw shaft 24 is provided, constituting a ball screw. Specifically, when the screw shaft 24 rotates, the numerous balls circulate inside the nut, and the nut moves along the Y-axis direction. Further, this nut is fixed to a reverse side of the Y-axis moving plate 22. Hence, when the screw shaft 24 is rotated by the motor 26, the Y-axis moving plate 22 moves together with the nut along the Y-axis direction.

To a front surface of the Y-axis moving plate 22, the Z-axis moving mechanism 16 is fixed. The Z-axis moving mechanism 16 includes a pair of guide rails 28 that are fixed to the front surface of the Y-axis moving plate 22 and that extend along the Z-axis direction. To a front side of the pair of Z-axis guide rails 28, a Z-axis moving plate 30 is coupled in a slidable manner along the pair of Z-axis guide rails 28. Between the pair of Z-axis guide rails 28, a screw shaft 32 extending along the Z-axis direction is disposed. To one end portion of the screw shaft 32, a motor 34 for rotating the screw shaft 32 is coupled. On a surface of the screw shaft 32 in which a spiral groove is formed, an unillustrated nut accommodating numerous balls that roll on the surface of the rotating screw shaft 32 is provided, constituting a ball screw. Specifically, when the screw shaft 32 rotates, the numerous balls circulate inside the nut, and the nut moves along the Z-axis direction. Further, this nut is fixed to a reverse side of the Z-axis moving plate 30. Hence, when the screw shaft 32 is rotated by the motor 34, the Z-axis moving plate 30 moves together with the nut along the Z-axis direction.

To a front surface of the Z-axis moving plate 30, a support plate 38 for supporting the holding unit 10 and a rotation unit 36 for rotating the holding unit 10 is fixed. On the support plate 38, the rotation unit 36 is placed, and part of the configuration of the holding unit 10 is protruding downward from the support plate 38. The holding unit 10 includes a suction section 40 protruding downward from the support plate 38 and a shaft section 42 that is coupled to the suction section 40 and that is protruding upward from the support plate 38. The suction section 40 has a lower surface serving as a holding surface 40a. The holding unit 10 includes an unillustrated suction channel communicating with the holding surface 40a and an unillustrated suction source such as an ejector that is connected to the suction channel. The holding surface 40a has an outer diameter smaller than a diameter of the workpiece 11. The holding unit 10 holds under attraction the workpiece 11 that has come into contact with the holding surface 40a.

The rotation unit 36 includes a casing 44, a motor 46 protruding upward from the casing 44, and a rotational shaft 48 an upper end side of which is housed in a rotatable manner in the casing 44 and a lower end side of which is protruding downward from the casing 44. The casing 44 is fixed to the support plate 38. The upper end of the rotational shaft 48 is connected to the motor 46, and hence, when the motor 46 is actuated, the rotational shaft 48 rotates about the Z-axis direction. A belt 50 is wound around the rotational shaft 48 of the rotation unit 36 and the shaft section 42 of the holding unit 10. Accordingly, when the rotational shaft 48 is rotated by the motor 46, the belt 50 rotates the shaft section 42. That is, the holding unit 10 rotates about the Z-axis direction. In other words, the rotation unit 36 functions as a rotation mechanism that rotates the holding unit 10 about a rotational axis that is a straight line intersecting the holding surface 40a (suction surface) of the holding unit 10.

On a front surface 8a of the support section 8, an X-axis moving mechanism 52 for moving the laser beam application unit 12 along the X-axis direction is provided. Further, the support section 8 is provided with a through hole 55 for connecting a front side and a rear side of the support section 8. Part of the configuration of the laser beam application unit 12 can move along the X-axis direction by the X-axis moving mechanism 52 in a state of being passed through the through hole 55.

The X-axis moving mechanism 52 includes a pair of X-axis guide rails 54 that are fixed to the front surface 8a of the support section 8 and that extend along the X-axis direction. To a front side of the pair of X-axis guide rails 54, an X-axis moving plate 56 is coupled in a slidable manner along the pair of X-axis guide rails 54. Further, adjacent to the pair of X-axis guide rails 54, a screw shaft 58 extending along the X-axis direction is provided. To one end portion of the screw shaft 58, a motor 60 for rotating the screw shaft 58 is coupled. Further, on a surface of the screw shaft 58 in which a spiral groove is formed, an unillustrated nut accommodating numerous balls that roll on the surface of the rotating screw shaft 58 is provided, constituting a ball screw. The nut is fixed to a reverse side of the X-axis moving plate 56. Hence, when the screw shaft 58 is rotated by the motor 60, the X-axis moving plate 56 moves together with the nut along the X-axis direction.

To the X-axis moving plate 56, a position detection unit 62 is fixed in addition to the laser beam application unit 12. The position detection unit 62 is mainly used at the time of performing alignment work for the laser beam application unit 12, and detects the position of the workpiece 11 held on the holding unit 10. The position detection unit 62 includes, for example, light receiving elements such as a complementary metal oxide semiconductor (CMOS) sensor and a charge coupled device (CCD) sensor, and detects the position of the workpiece 11 by detecting light reflected from the workpiece 11.

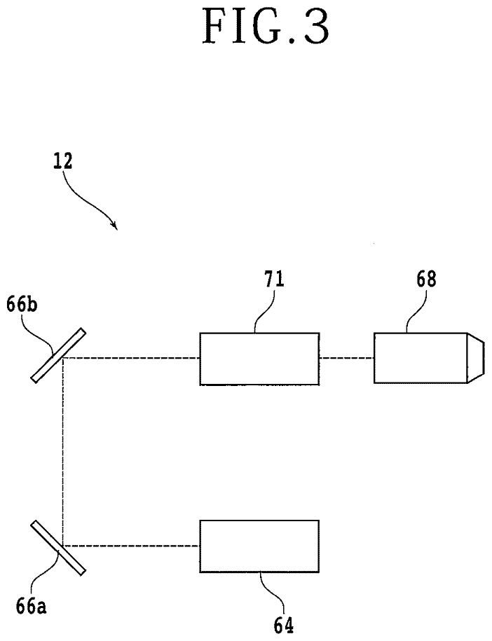

Next, the configuration of the laser beam application unit 12 is described. FIG. 3 is a view schematically illustrating an easiest configuration example of the laser beam application unit 12. Note that, in FIG. 3, some of the components of the laser beam application unit 12 are illustrated in block forms.

The laser beam application unit 12 includes an oscillator 64. The oscillator 64 is fixed to the base 4, for example. The oscillator 64 includes, for example, neodymium-doped yttrium aluminum garnet (Nd:YAG) as the laser medium, and emits a laser beam having a wavelength (for example, 355 nm) that is absorbable by the material constituting the workpiece 11. The laser beam emitted from the oscillator 64 is reflected by mirrors 66a and 66b and supplied to a beam condenser 68. The beam condenser 68 includes a condenser lens for converging laser beams, for example. The laser beams that have passed through this condenser lens are emitted from the beam condenser 68 toward the workpiece 11 held on the holding unit 10. Note that, the beam condenser 68 is provided at a distal end portion of a cylindrical housing 70 (see FIG. 2). A proximal end portion of the housing 70 is fixed to the X-axis moving plate 56.

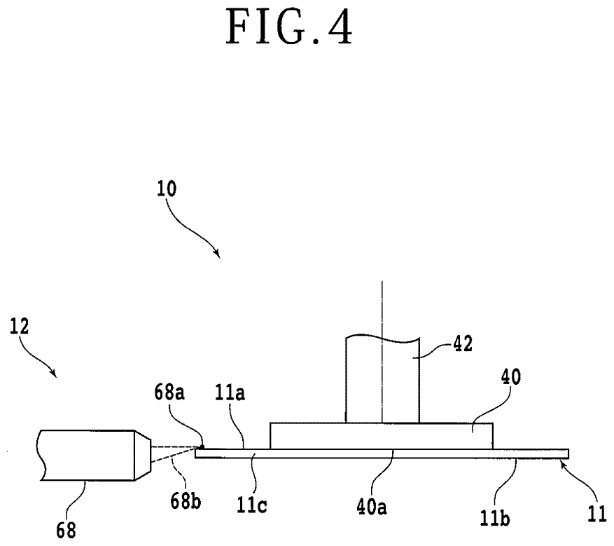

FIG. 4 is a side elevational view schematically illustrating the manner in which a laser beam 68b is applied from the side to the workpiece 11 held on the holding unit 10. The beam condenser 68 has a function of converging the laser beam 68b on a focused spot 68a. When the X-axis moving plate 56 moves, the beam condenser 68 moves together with the housing 70, so that the position of the focused spot 68a with respect to the holding unit 10 moves as well. Further, even if the holding unit 10 is moved, it is the position of the focused spot 68a that moves relative to the holding unit 10. Specifically, the X-axis moving mechanism 52, the Y-axis moving mechanism 14, and the Z-axis moving mechanism 16 function as a moving mechanism that moves the holding unit 10 and the focused spot 68a of the laser beam 68b relative to each other. The plurality of mirrors 66a and 66b included in the laser beam application unit 12 are disposed at positions and orientations that allow the laser beam 68b to be supplied to the beam condenser 68 that moves along the X-axis direction. Moreover, one of the mirrors 66a and 66b may be configured to have its position and orientation changeable in a manner corresponding to the movement of the beam condenser 68.

The laser beam application unit 12 further includes an angle adjustment unit 71 (see FIG. 3) between the oscillator 64 and the beam condenser 68 in the traveling path of the laser beam 68b. The angle adjustment unit 71 has a function of adjusting the traveling direction of the laser beam 68b. The angle adjustment unit 71 may, for example, be configured by a galvanoscanner, an acousto-optic deflector (AOD), or a polygon mirror. Yet, the angle adjustment unit 71 is not limited to such examples. Note that, depending on the configuration of the angle adjustment unit 71, an fθ lens may be provided in the beam condenser 68.

Controlling the moving mechanisms (the X-axis moving mechanism 52, the Y-axis moving mechanism 14, and the Z-axis moving mechanism 16) and the angle adjustment unit 71 makes it possible to change the position of the focused spot 68a with respect to the workpiece 11 held on the holding unit 10 and the traveling direction of the laser beam 68b to be converged on the focused spot 68a. Further, the moving mechanisms and the angle adjustment unit 71 can adjust the relative positions and the orientations of the beam condenser 68 and the holding unit 10 such that the beam condenser 68 faces the side surface 11c that connects the first surface 11a and the second surface 11b of the workpiece 11 held on the holding unit 10. Further, the laser beam application unit 12 of the laser processing apparatus 2 can apply, from the side surface 11c to the workpiece 11 held on the holding unit 10, the laser beam 68b emitted from the oscillator 64 and converged by the beam condenser 68. Further, the laser beam application unit 12 can also adjust the traveling direction of the laser beam 68b such that the laser beam 68b enters the workpiece 11 from the side surface 11c thereof and then travels up to the first surface 11a or the second surface 11b. Here, the position detection unit 62 detects the positional relation between the beam condenser 68 and the side surface 11c of the workpiece 11 held on the holding unit 10. Hence, the position detection unit 62 is used at the time of adjusting the position of the focused spot 68a with respect to the workpiece 11 and the traveling direction of the laser beam 68b.

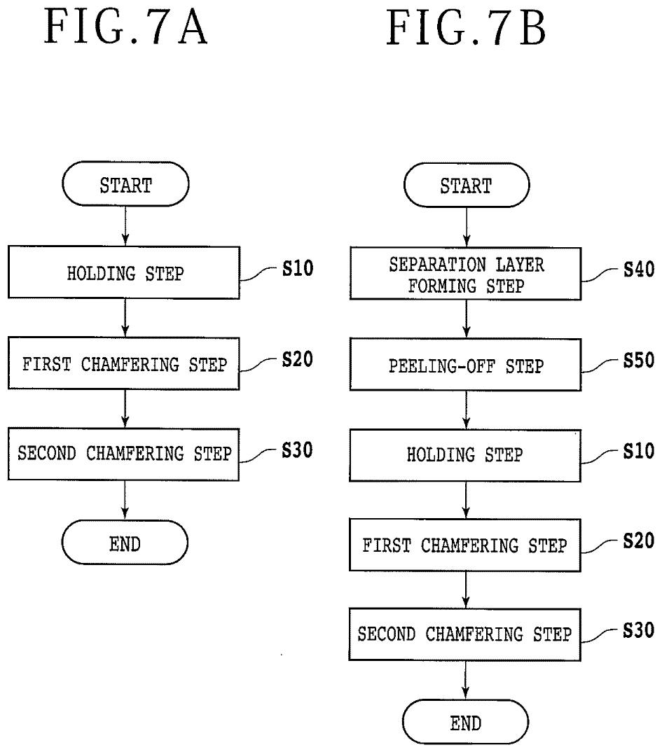

Next, a procedure for performing chamfer processing on the workpiece 11 with use of the laser processing apparatus 2 configured as described above will be explained. Specifically, a workpiece chamfering method for chamfering the workpiece 11 will be described. FIG. 7A is a flowchart illustrating a flow of steps of the workpiece chamfering method.

In the workpiece chamfering method illustrated in FIG. 7A, first, a holding step S10 of holding a central portion of the first surface 11a side of the workpiece 11 on the flat holding surface 40a of the suction section 40 of the holding unit 10 such that an outer peripheral portion (a portion including the side surface 11c) of the workpiece 11 is exposed is carried out.

More specifically, in the holding step S10, a conveying unit included in the laser processing apparatus 2 holds and conveys the workpiece 11 while passing it through the loading/unloading port 18, to bring the workpiece 11 into contact with the holding surface 40a of the suction section 40 of the holding unit 10. At this time, the central portion of the first surface 11a side is caused to face the holding surface 40a in such a manner that the outer peripheral portion of the workpiece 11 does not overlap with the holding surface 40a. Next, the suction source connected to the suction section 40 is actuated to start holding under suction the workpiece 11 by the suction section 40 of the holding unit 10. As a result, suction force acts on the central portion of the first surface 11a side of the workpiece 11, and the workpiece 11 is held under suction on the holding surface 40a. At this time, both the outer peripheral portion of the first surface 11a side of the workpiece 11 and the outer peripheral portion of the second surface 11b side of the workpiece 11 are exposed. Thereafter, holding of the workpiece 11 by the conveying unit is cancelled, and the conveying unit is retracted from a position near the holding unit 10 by being passed through the loading/unloading port 18. This completes the holding step S10. FIG. 4 includes a side elevational view schematically illustrating the workpiece 11 held on the holding unit 10.

Note that, for the purpose of processing a predetermined position on the outer peripheral portion of the workpiece 11 in the laser processing apparatus 2, a step of specifying positions of points on the side surface 11c of the workpiece 11 may be carried out after the workpiece 11 is held by the holding unit 10. In this step, the relative positions of the holding unit 10 and the position detection unit 62 are adjusted by the moving mechanisms (the X-axis moving mechanism 52, the Y-axis moving mechanism 14, and the Z-axis moving mechanism 16), to cause the side surface 11c of the workpiece 11 to face the position detection unit 62. Further, the workpiece 11 is imaged by the light receiving elements of the position detection unit 62 such that an image (overall image) including the outer peripheral portion of the workpiece 11 is formed. For example, imaging of a region including part of the outer peripheral portion of the workpiece 11 and rotation and movement of the suction section 40 are alternately repeated. Thereafter, a plurality of images (partial images) formed by a plurality of times of imaging using the light receiving elements are combined to form an overall image.

Next, the position of the outer peripheral portion of the workpiece 11 is identified in reference to the formed image. For example, an outer peripheral edge of the workpiece 11 is identified by binarizing the formed image with use of a processor or the like built in the laser processing apparatus 2. Note that, at this time, linearly extending portions of the identified outer peripheral edge are identified as the positions of the first orientation flat 13a and the second orientation flat 13b. In a first chamfering step S20 and a second chamfering step S30 described below, the moving mechanisms can be operated in such a manner that a predetermined position of the workpiece 11 can be processed by referring to the positions of the points on the side surface 11c of the workpiece 11.

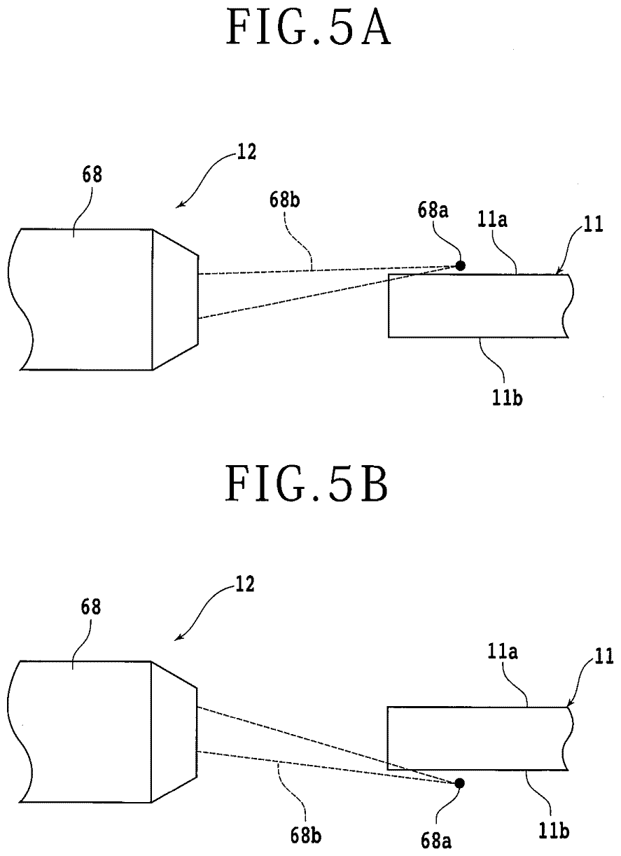

In the workpiece chamfering method illustrated in FIG. 7A, the first chamfering step S20 is carried out after the holding step S10. In the first chamfering step S20, the outer peripheral portion of the first surface 11a side of the workpiece 11 is removed. FIG. 5A is a side elevational view schematically illustrating the beam condenser 68 and the workpiece 11 at the time when the first chamfering step S20 is carried out. In the first chamfering step S20, first, the traveling direction of the laser beam 68b and the position of the focused spot 68a are adjusted before the laser beam 68b is applied to the workpiece 11.

More specifically, the focused spot 68a is positioned near the outer peripheral portion of the workpiece 11 and on an outer side of the first surface 11a side. Next, the traveling direction of the laser beam 68b is adjusted such that the laser beam 68b passes through the workpiece 11 and reaches up to the first surface 11a of the workpiece 11 when the laser beam 68b is applied to the side surface 11c of the workpiece 11. Thereafter, the laser beam application unit 12 is operated, and the laser beam 68b having a wavelength absorbable by the material constituting the workpiece 11 is applied to the workpiece 11 in such a manner as to enter the workpiece 11 from the side surface 11c thereof and reach up to the first surface 11a side. At this time, the holding unit 10 (suction section 40) is rotated about a rotational axis that is a straight line intersecting the holding surface 40a. As a result, the laser beam 68b is applied over the entire circumference of the outer peripheral portion of the first surface 11a side of the workpiece 11, and the outer peripheral portion of the first surface 11a side of the workpiece 11 is removed. Here, the conditions of applying the laser beam 68b to the workpiece 11 are, for example, set as follows. Yet, the application conditions are not limited to the following example.
Wavelength: 355 nm
Repetition frequency: 50 kHz
Average output: 2.0 W

Note that, the moving mechanisms are preferably operated such that, when the holding unit 10 is rotated, the distance between the side surface 11c of the workpiece 11 and the beam condenser 68 is constant, with reference to the orientation of the workpiece 11 at each time point and the position of the side surface 11c of the workpiece 11. This allows the angled portions to be removed by ablation processing in a similar manner at each of the points on the side surface 11c of the workpiece 11 and a uniform-shaped chamfered portion to be formed over the entire circumference of the outer peripheral portion of the first surface 11a side of the workpiece 11.

Further, in the workpiece chamfering method illustrated in FIG. 7A, the second chamfering step S30 is performed after the holding step S10. For example, the second chamfering step S30 is carried out after the first chamfering step S20. Yet, the second chamfering step S30 may be carried out before the first chamfering step S20.

In the second chamfering step S30, the outer peripheral portion of the second surface 11b side of the workpiece 11 is removed. FIG. 5B is a side elevational view schematically illustrating the beam condenser 68 and the workpiece 11 at the time when the second chamfering step S30 is carried out. In the second chamfering step S30, as in the first chamfering step S20, the traveling direction of the laser beam 68b and the position of the focused spot 68a are adjusted before the laser beam 68b is applied to the workpiece 11. More specifically, the focused spot 68a is positioned near the outer peripheral portion of the workpiece 11 and on an outer side of the second surface 11b side. Further, the traveling direction of the laser beam 68b is adjusted such that the laser beam 68b passes through the workpiece 11 and reaches up to the second surface 11b of the workpiece 11 when the laser beam 68b is applied to the side surface 11c of the workpiece 11.

Thereafter, the laser beam application unit 12 is operated, and the laser beam 68b having a wavelength absorbable by the material constituting the workpiece 11 is applied to the workpiece 11 in such a manner as to enter the workpiece 11 from the side surface 11c thereof and reach up to the second surface 11b side. At this time, the holding unit 10 (suction section 40) is rotated about a rotational axis that is a straight line intersecting the holding surface 40a. As a result, the outer peripheral portion of the second surface 11b side of the workpiece 11 is removed over the entire circumference. Note that, also in the second chamfering step S30, the moving mechanisms and the like are operated such that the angled portions are removed in a similar manner at each of the positions on the side surface 11c of the workpiece 11 and a uniform-shaped chamfered portion is formed over the entire circumference of the outer peripheral portion of the second surface 11b side. This forms the chamfered portion also on the outer peripheral portion of the second surface 11b side in a similar shape as that formed on the outer peripheral portion of the first surface 11a side, by ablation processing.

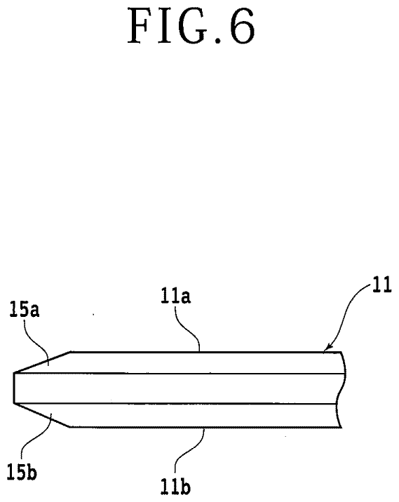

FIG. 6 is a partial side elevational view schematically illustrating, in an enlarged form, the workpiece 11 in which chamfered portions are formed in the outer peripheral portions thereof. When the first chamfering step S20 and the second chamfering step S30 are performed, as illustrated in FIG. 6, a first recess 15a is formed in the outer peripheral portion of the first surface 11a side of the workpiece 11, and a second recess 15b is formed in the outer peripheral portion of the second surface 11b side. That is, the chamfered portions configured by the first recess 15a and the second recess 15b are formed in the outer peripheral portions of the workpiece 11. Note that the recesses 15a and 15b are illustrated in FIG. 6 as each having a surface that has a shape corresponding to a side surface of a circular truncated cone, but the recesses 15a and 15b configuring the chamfered portions are not limited to having such a shape. For example, the chamfered portions may each have a surface curved in longitudinal section. Moreover, in the first chamfering step S20 and the second chamfering step S30, the workpiece 11 and the focused spot 68a may be moved relative to each other along the thickness direction of the workpiece 11 such that the surface of each of the chamfered portions has a desired shape.

After the first chamfering step S20 and the second chamfering step S30, the conveying unit is brought into contact with the workpiece 11 held under attraction by the suction section 40, to hold the workpiece 11 and cancel the suction-holding of the workpiece 11 by the suction section 40. Thereafter, the conveying unit is moved to unload the workpiece 11 from a position near the holding unit 10. This produces the workpiece 11 which has undergone chamfering processing.

Here, in the laser processing apparatus 2 according to the present embodiment, the workpiece 11 need not be turned upside down between the first chamfering step S20 and the second chamfering step S30. This is because the two chamfering steps can successively be performed by mere movement of the focused spot 68a between the outer portion of the first surface 11a of the workpiece 11 and the outer portion of the second surface 11b between the first chamfering step S20 and the second chamfering step S30. Thus, in the laser processing apparatus 2, chamfer portions can be formed in the outer peripheral portions of the workpiece 11 without time being taken for tuning the workpiece 11 upside down. Moreover, in this case, a step of precisely detecting again the position of the outer periphery which is to be processed in the workpiece 11 and deciding the processing position after the workpiece 11 has been turned upside down is also unnecessary. Hence, this method increases the throughput in the chamfering processing.

Here, in the laser processing apparatus 2 according to the present embodiment, a wafer whose second surface is coarser than its first surface may be used as the workpiece. Such a wafer is, for example, manufactured by being separated from an ingot. The wafer which has just been separated from the ingot has no chamfered portion in the outer peripheral portion thereof, and is hence prone to damage. Hence, in the process of manufacturing a wafer from an ingot, the laser processing apparatus 2 may be used for the chamfering process.

Next, a wafer manufacturing method for forming a chamfered wafer from an ingot by using the laser processing apparatus 2 in some of the steps will be described. FIG. 7B is a flowchart illustrating a flow of steps of the wafer manufacturing method. In this wafer manufacturing method, the abovementioned workpiece chamfering method is carried out by the laser processing apparatus 2 with use of a wafer as the workpiece 11 after the wafer has been separated from an ingot.

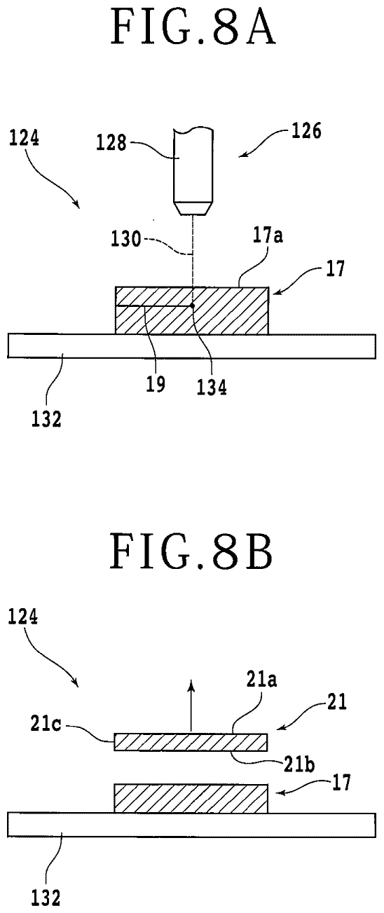

In the wafer manufacturing method illustrated in FIG. 7B, first, a separation layer forming step S40 is carried out. FIG. 8A is a cross sectional view schematically illustrating an ingot 17 in which forming of a separation layer 19 is being performed in the separation layer forming step S40. In the separation layer forming step S40, a laser processing apparatus 124 that can apply, to the ingot 17, a first laser beam 130 having a wavelength transmittable through the material constituting the ingot 17 is used.

The laser processing apparatus 124 used in the separation layer forming step S40 includes a holding table 132 for holding a workpiece such as the ingot 17 and a laser beam application unit 126 for applying the first laser beam 130 to the workpiece held on the holding table 132. The holding table 132 is, for example, a chuck table that can suck and hold the workpiece placed thereon. The laser beam application unit 126 includes an unillustrated oscillator for emitting the first laser beam 130 and a beam condenser 128 for converging the first laser beam 130 emitted from the oscillator on the workpiece held on the holding table 132. Moreover, the laser beam application unit 126 includes an optical system for guiding the first laser beam 130 from the oscillator to the beam condenser 128. The laser processing apparatus 124 further includes an unillustrated moving unit that moves the holding table 132 and the laser beam application unit 126 (beam condenser 128) relative to each other in a direction parallel to an upper surface of the holding table 132.

In the separation layer forming step S40, first, the ingot 17 is conveyed to the holding table 132, and is held under suction on the holding table 132. Next, a first focused spot 134 of the first laser beam 130 to be converged by the beam condenser 128 of the laser beam application unit 126 is positioned to a predetermined depth position inside the ingot 17. For example, the first focused spot 134 is positioned to a position that is approximately 100 μm deep from an upper surface 17a of the ingot 17. Thereafter, the ingot 17 and the first focused spot 134 are moved relative to each other while the laser beam application unit 126 is operated and the first laser beam 130 is applied toward the upper surface 17a of the ingot 17 and is converged on the first focused spot 134. Relative movement of the ingot 17 and the first focused spot 134 is performed by the moving unit described above. Here, the conditions of applying the first laser beam 130 to the ingot 17 are, for example, set as follows. Yet, the application conditions are not limited to the following example.
Wavelength: 1064 nm
Repetition frequency: 60 kHz
Average output: 1.5 W

When the first laser beam 130 is applied to the ingot 17, the separation layer 19 including modified portions and cracks extending from the modified portions is formed near the first focused spot 134 inside the ingot 17. Further, when the first laser beam 130 is applied to the ingot 17 while the first focused spot 134 is scanned over the entire surface parallel to the upper surface 17a of the ingot 17, the separation layer 19 substantially parallel to the upper surface 17a of the ingot 17 is formed in the ingot 17.

In the wafer manufacturing method illustrated in FIG. 7B, after the separation layer forming step S40, a peeling-off step S50 of peeling off a wafer from the ingot 17 by applying external force to the ingot 17 such that the ingot 17 is cleaved in the separation layer 19 is carried out. FIG. 8B is a cross sectional view schematically illustrating the manner in which a wafer 21 is peeled off from the ingot 17 in the peeling-off step S50.

In the peeling-off step S50, the cracks included in the separation layer 19 further extend, so that the ingot 17 is cleaved. As a result, due to this cleavage, the wafer 21 whose second surface 21b (that is, a cleaved surface on the separation layer 19 side) is coarser than its first surface 21a (that is, a surface corresponding to the upper surface 17a of the ingot 17) is peeled off from the ingot 17. After the peeling-off step S50, for example, the workpiece chamfering method explained with reference to FIG. 7A is performed in the laser processing apparatus 2 with use of the wafer 21 as the workpiece 11.

That is, after the peeling-off step S50, the holding step S10 described with use of FIG. 4 and other relevant drawings is carried out. In the holding step S10, a central portion of the first surface 21a side of the wafer 21 is held on the flat holding surface 40a of the holding unit 10 (suction section 40) such that both an outer peripheral portion of the first surface 21a side of the wafer 21 and an outer peripheral portion of the second surface 21b side of the wafer 21 are exposed. After the holding step S10, the first chamfering step S20 described with use of FIG. 5A and other relevant drawings is carried out. In the first chamfering step S20, a second laser beam (laser beam 68b) having a wavelength absorbable by the material constituting the wafer 21 is applied to the wafer 21 in such a manner as to enter the wafer 21 from a side surface 21c thereof and reach up to the first surface 21a side of the wafer 21. Then, the holding unit 10 (suction section 40) is rotated about a rotational axis that is a straight line intersecting the holding surface 40a, while the second laser beam is being applied to the wafer 21, so that the outer peripheral portion of the first surface 21a side of the wafer 21 is removed.

Further, after the holding step S10, the second chamfering step S30 described with use of FIG. 5B and other relevant drawings is carried out. In the second chamfering step S30, the second laser beam (laser beam 68b) is applied to the wafer 21 in such a manner as to enter the wafer 21 from the side surface 21c thereof and reach up to the second surface 21b side. Thereafter, the holding unit 10 (suction section 40) is rotated about the rotational axis described above, while the second laser beam is being applied to the wafer 21, so that the outer peripheral portion of the second surface 21b side of the wafer 21 is removed. As a result, a chamfered wafer 21 is manufactured. In the wafer manufacturing method illustrated in FIG. 7B, the wafer 21 need not particularly be turned upside down between the first chamfering step S20 and the second chamfering step S30. Hence, a chamfered wafer 21 can be manufactured without the throughput being lowered. Note that the second chamfering step S30 may be performed before the first chamfering step S20.

Here, in the present embodiment, the workpiece processing method (wafer manufacturing method) in which the second chamfering step S30 is performed before or after the first chamfering step S20 in the laser processing apparatus 2 has been explained. However, an aspect of the present invention is not limited to such an example. Specifically, the second chamfering step S30 may be performed simultaneously with the first chamfering step S20. In order to simultaneously perform the first chamfering step S20 and the second chamfering step S30 in the laser processing apparatus 2, the laser beam application unit 12 that converges the laser beams 68b on the two focused spots 68a is used. In this case, the optical system of the laser beam application unit 12 preferably includes a diffractive optical element (DOE), for example, a diffractive beam splitter.

In the first chamfering step S20 and the second chamfering step S30 performed simultaneously, the focused spot 68a is positioned to each of the outer portion of the first surface 11a side of the workpiece 11 and the outer portion of the second surface 11b side of the workpiece 11. That is, the two focused spots 68a are positioned in such a manner as to sandwich the workpiece 11. In this state, the laser beam 68b is applied to the side surface 11c of the workpiece 11 in such a manner as to be converged on each of the focused spots 68a. In this case, the outer peripheral portion of the first surface 11a side of the workpiece 11 and the outer peripheral portion of the second surface 11b side of the workpiece 11 are removed simultaneously, and chamfered portions are formed in the workpiece 11. Hence, the throughput at the time of chamfering the workpiece 11 further increases.

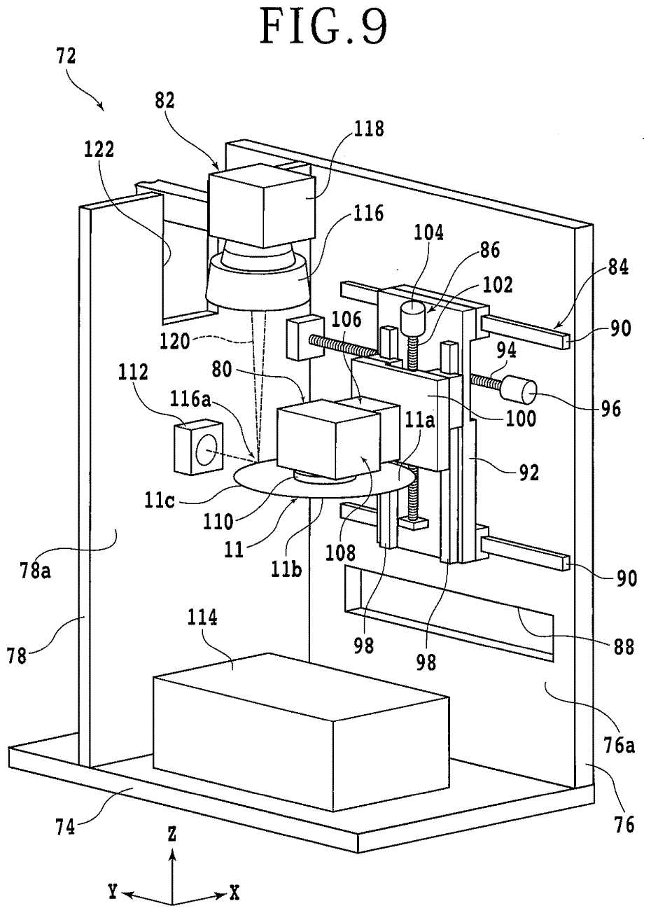

In the present embodiment, a case where the laser processing apparatus 2 applies the laser beam 68b from the horizontal direction toward the side surface 11c of the workpiece 11 has been explained, but the aspect of the present invention is not limited to such an example. Specifically, the laser processing apparatus according to an aspect of the present invention may be able to apply a laser beam from a vertical direction toward the side surface 11c of the workpiece 11. In regard to this, a laser processing apparatus according to a modification will next be explained. FIG. 9 is a perspective view schematically illustrating a laser processing apparatus 72 according to the modification. Note that the laser processing apparatus 72 illustrated in FIG. 9 has many components same as those of the laser processing apparatus 2 explained with reference to FIG. 2 and other relevant drawings. Hence, the same names as those of the components of the laser processing apparatus 2 are given to the components of the laser processing apparatus 72 described below that correspond to the components of the laser processing apparatus 2. Since the description made for the laser processing apparatus 2 can be used for the description of such components as appropriate, description regarding some of the components is omitted in the following description.

The laser processing apparatus 72 illustrated in FIG. 9 includes a base 74 that supports the components. On the base 74, a support section 76 for mainly supporting the holding unit 80 that holds the workpiece 11 and a support section 78 for mainly supporting a laser beam application unit 82 that applies a laser beam 120 to the workpiece 11 are erected. On a front surface 76a of the support section 76, a Y-axis moving mechanism 84 for moving the holding unit 80 along the Y-axis direction and a Z-axis moving mechanism 86 for moving the holding unit 80 along the Z-axis direction are provided. Moreover, the support section 76 is provided with a loading/unloading port 88 that serves as a movement path for the workpiece 11 that moves between a front side and a rear side of the support section 76.

The Y-axis moving mechanism 84 includes a pair of Y-axis guide rails 90 that are fixed to the front surface 76a of the support section 76 and that extend along the Y-axis direction. To a front side of the pair of Y-axis guide rails 90, a Y-axis moving plate 92 is coupled in a slidable manner along the pair of Y-axis guide rails 90. Further, between the pair of Y-axis guide rails 90, a screw shaft 94 extending along the Y-axis direction is disposed. To a front end portion (one end portion) of the screw shaft 94, a motor 96 for rotating the screw shaft 94 is coupled. On a surface of the screw shaft 94 in which a spiral groove is formed, an unillustrated nut accommodating numerous balls that roll on the surface of the rotating screw shaft 94 is provided, constituting a ball screw. When the screw shaft 94 is rotated by the motor 96, the Y-axis moving plate 92 moves together with the nut along the Y-axis direction.

To a front surface of the Y-axis moving plate 92, the Z-axis moving mechanism 86 is fixed. To the Z-axis moving mechanism 86, a pair of Z-axis guide rails 98 that are fixed to the front surface of the Y-axis moving plate 92 and that extend along the Z-axis direction are fixed. To a front side of the pair of Z-axis guide rails 98, a Z-axis moving plate 100 is coupled in a slidable manner along the pair of Z-axis guide rails 98. Between the pair of Z-axis guide rails 98, a screw shaft 102 extending along the Z-axis direction is disposed. To a front end portion (one end portion) of the screw shaft 102, a motor 104 for rotating the screw shaft 102 is coupled. Further, on a surface of the screw shaft 102 in which a spiral groove is formed, an unillustrated nut accommodating numerous balls that roll on the surface of the rotating screw shaft 102 is provided, constituting a ball screw. When the screw shaft 102 is rotated by the motor 104, the Z-axis moving plate 100 moves together with the nut along the Z-axis direction.

To a front surface of the Z-axis moving plate 100, a holding unit 80 and a rotation unit 108 for rotating the holding unit 80 (suction section 110) are fixed. The holding unit 80 and the rotation unit 108 have similar configurations as those of the holding unit 10 and the rotation unit 36 illustrated in FIG. 2 and other drawings. Specifically, the holding unit 80 includes the suction section 110 which has a lower surface serving as a holding surface. The suction section 110 can hold under suction the workpiece 11 that comes into contact with the holding surface. The rotation unit 108 is a rotation mechanism that rotates the holding unit 80 about a rotational axis that is a straight line intersecting the holding surface (suction surface) of the suction section 110 of the holding unit 80. Further, the laser processing apparatus 72 according to the modification illustrated in FIG. 9 includes an orientation changing unit 106 for changing the orientation of the holding unit 80, on the front surface of the Z-axis moving plate 100. The holding unit 80 is supported by the Z-axis moving plate 100 via the orientation changing unit 106. The orientation changing unit 106 rotates the holding unit 80 about a rotational axis that extends along a direction (for example, the X-axis direction) parallel to the holding surface of the suction section 110.

In the support section 78, a through hole 122 connecting a front side and a rear side of the support section 78 is formed. Part or all of the configuration of the laser beam application unit 82 is provided on the front side of the support section 78 in a state of being passed through the through hole 122. To a front surface 78a of the support section 78, a position detection unit 112 is fixed. The position detection unit 112 is used mainly for performing alignment work for the laser beam application unit 82 and detects the position of the workpiece 11 held on the holding unit 80. The position detection unit 112 includes light receiving elements, and detects the position of the workpiece 11 by detecting the light reflected from the workpiece 11.

The laser beam application unit 82 is configured in a manner similar to that of the laser beam application unit 12 of the laser processing apparatus 2 illustrated in FIG. 2 and other drawings. The laser beam application unit 82 includes an unillustrated oscillator for emitting the laser beam 120 and a beam condenser 116 for converging the laser beam 120 emitted from the oscillator on a focused spot 116a. The beam condenser 116 includes condenser lens for converging the laser beam 120, for example. Note that, as illustrated in FIG. 9, the beam condenser 116 is disposed on the upper side of the workpiece 11 held on the holding unit 80, and the laser beam application unit 82 applies the laser beam 120 toward the workpiece 11 from the upper side. Further, the laser beam application unit 82 includes an angle adjustment unit 118 on a traveling path of the laser beam 120 from the oscillator to the beam condenser 116. The angle adjustment unit 118 has the function of adjusting the traveling direction of the laser beam 120.

Controlling the moving mechanisms (the Y-axis moving mechanism 84 and the Z-axis moving mechanism 86) and the angle adjustment unit 118 makes it possible to change the position of the focused spot 116a with respect to the workpiece 11 held on the holding unit 80 and the traveling direction of the laser beam 120 that is to be converged on the focused spot 116a. Further, the moving mechanisms and the angle adjustment unit 118 can adjust the relative positions and the orientations of the beam condenser 116 and the holding unit 80 such that the beam condenser 116 faces the side surface 11c that connects the first surface 11a and the second surface 11b of the workpiece 11 held on the holding unit 80.

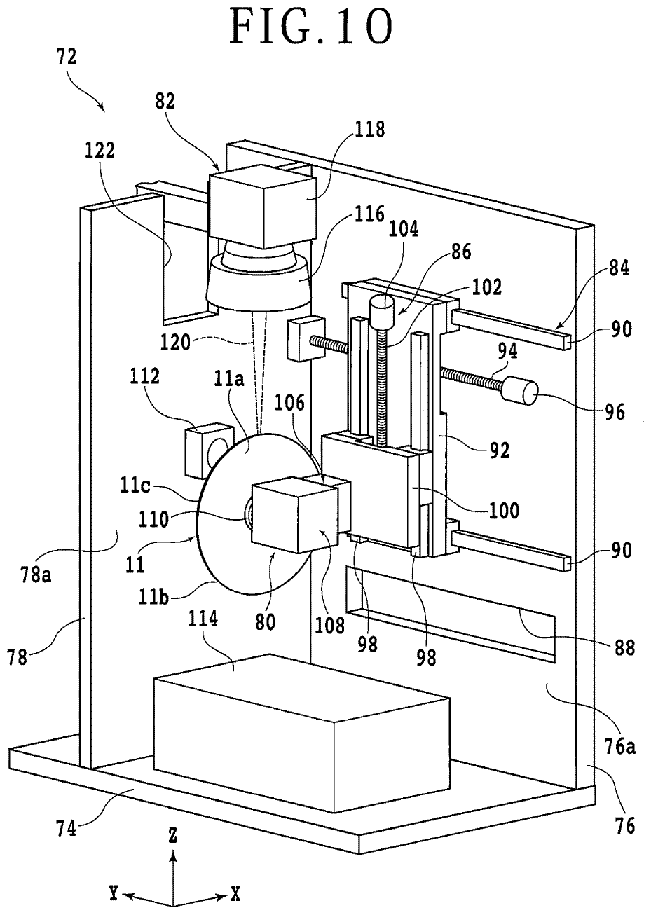

Here, when the workpiece 11 is to be held under suction on the suction section 110 of the holding unit 80, the orientation changing unit 106 is operated such that the holding surface of the suction section 110 becomes substantially parallel to the X-axis direction and the Y-axis direction. When the central portion of the first surface 11a of the workpiece 11 is brought into contact with the holding surface of the suction section 110 and the workpiece 11 is held under suction by the suction section 110 in this state, the outer peripheral portion of the first surface 11a of the workpiece 11 is positioned right below the beam condenser 116. Further, in the laser processing apparatus 72 according to the modification, when the orientation changing unit 106 is operated in a state in which the holding unit 80 is holding the workpiece 11, the orientation of the workpiece 11 can be changed. For example, when the orientation changing unit 106 is operated to make a 90° rotation, the holding surface of the suction section 110 becomes parallel to the X-axis direction and the Z-axis direction, and the orientation of the workpiece 11 is changed. At this time, the side surface 11c of the workpiece 11 faces the beam condenser 116 of the laser beam application unit 82. FIG. 10 is a perspective view schematically illustrating the laser processing apparatus 72 when the side surface 11c of the workpiece 11 faces the beam condenser 116.

Since the laser processing apparatus 72 according to the modification includes the orientation changing unit 106, the laser processing apparatus 72 can apply the laser beam 120 to both the outer peripheral portion of the first surface 11a side of the workpiece 11 and the side surface 11c side of the workpiece 11. For example, applying the laser beam 120 to the first surface 11a of the workpiece 11 makes it possible to print characters and signs on the first surface 11a. Further, when the focused spot 116a or the like is adjusted such that the laser beam 120 enters the workpiece 11 from the side surface 11c thereof and travels up to the first surface 11a or the second surface 11b, chamfering processing can be applied to the workpiece 11 with use of the laser beam 120. Here, the position detection unit 112 detects a positional relation between the beam condenser 116 and the workpiece 11 held on the holding unit 80. Hence, the position detection unit 112 is used for adjusting the position of the focused spot 116a with respect to the workpiece 11 and the traveling direction of the laser beam 120.

Also in the laser processing apparatus 72 according to the modification, the laser beam 120 can be applied to the workpiece 11 from the side surface 11c side. Further, processing can be applied to the outer peripheral portion of the first surface 11a side of the workpiece 11 and the outer peripheral portion of the second surface 11b side of the workpiece 11 while the position of the focused spot 116a is being changed. At this time, since the workpiece 11 need not be turned upside down, the trouble taken for chamfering the workpiece 11 is reduced, and the throughput is increased. Moreover, in the laser processing apparatus 72 illustrated in FIGS. 9 and 10, the laser beam application unit 82 causes the laser beam 120 to travel from the beam condenser 116 along the Z-axis direction. Hence, even in a case where a door of a casing covering the components of the laser processing apparatus 72 happens to be opened due to some kind of malfunction while the laser beam 120 is being applied to the workpiece 11, the laser beam 120 would not travel outside the casing. This makes the laser processing apparatus 72 relatively high in safeness.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus capable of applying laser processing to a workpiece by applying, to the workpiece, a laser beam having a wavelength absorbable by a material constituting the workpiece, comprising:
a holding unit that has a flat holding surface;
an oscillator that emits the laser beam;
a beam condenser that converges the laser beam emitted from the oscillator;
a moving mechanism that moves the holding unit and a focused spot of the laser beam relative to each other; and
a rotation mechanism that rotates the holding unit about a rotational axis that is a straight line intersecting the holding surface of the holding unit, wherein
relative positions and orientations of the beam condenser and the holding unit are adjustable in such a manner that the beam condenser faces a side surface connecting a first surface and a second surface of the workpiece held by the holding unit, and
the laser beam emitted from the oscillator and converged by the beam condenser is applicable from the side surface side to the workpiece held by the holding unit.

2. The laser processing apparatus according to claim 1, wherein a traveling direction of the laser beam is adjustable in such a manner that the laser beam enters the workpiece from the side surface thereof and travels up to the first surface or the second surface.

3. The laser processing apparatus according to claim 1, further comprising:
a position detection unit that detects a positional relation between the beam condenser and the side surface of the workpiece held by the holding unit.

4. A workpiece chamfering method for chamfering a workpiece, comprising:
holding a central portion of a first surface side of the workpiece on a flat holding surface of a holding unit such that outer peripheral portions of the workpiece are exposed;
after the central portion of the first surface side of the workpiece is held on the flat holding surface of the holding unit, removing the outer peripheral portion of the first surface side of the workpiece by rotating the holding unit about a rotational axis that is a straight line intersecting the holding surface while applying, to the workpiece, a laser beam having a wavelength absorbable by a material constituting the workpiece such that the laser beam enters the workpiece from a side surface thereof and reaches up to the first surface side; and
after the central portion of the first surface side of the workpiece is held on the flat holding surface of the holding unit, removing the outer peripheral portion of the second surface side of the workpiece by rotating the holding unit about the rotational axis while applying the laser beam to the workpiece such that the laser beam enters the workpiece from the side surface thereof and reaches up to the second surface side.

5. The workpiece chamfering method according to claim 4, wherein the workpiece is not turned upside down between the removal of the outer peripheral portion of the first surface side of the workpiece and the removal of the outer peripheral portion of the second surface side of the workpiece.

6. A wafer manufacturing method for manufacturing a chamfered wafer from an ingot, comprising:
forming a separation layer inside the ingot by applying, to the ingot, a first laser beam having a wavelength transmittable through a material constituting the ingot in such a manner that the ingot and a first focused spot of the first laser beam are moved relative to each other in a state in which the first focused spot is positioned inside the ingot;
peeling off a wafer from the ingot by applying external force to the ingot in such a manner that the ingot is cleaved in the separation layer;
holding a central portion of a first surface side of the wafer on a flat holding surface of the holding unit such that both an outer peripheral portion of the first surface side of the wafer and an outer peripheral portion of a second surface side of the wafer are exposed;
after the central portion of the first surface side of the wafer is held on the flat holding surface of the holding unit, removing the outer peripheral portion of the first surface side of the wafer by rotating the holding unit about a rotational axis that is a straight line intersecting the holding surface while applying, to the wafer, a second laser beam having a wavelength absorbable by a material constituting the wafer in such a manner that the second laser beam enters the wafer from a side surface thereof and reaches up to the first surface side; and
after the central portion of the first surface side of the wafer is held on the flat holding surface of the holding unit, removing the outer peripheral portion of the second surface side of the wafer by rotating the holding unit about the rotational axis while applying the second laser beam to the wafer in such a manner that the second laser beam enters the wafer from the side surface thereof and reaches up to the second surface side.

7. The wafer manufacturing method according to claim 6, wherein the wafer is not turned upside down between the removal of the outer peripheral portion of the first surface side of the wafer and the removal of the outer peripheral portion of the second surface side of the wafer.
